(19) United States
(12) Patent Application Publication
(10) Pub. No.: US 2024/0193399 A1
(43) Pub. Date: Jun. 13, 2024

(54) LEARNING LANGUAGE REPRESENTATION WITH LOGICAL INDUCTIVE BIAS

(71) Applicant: TENCENT AMERICA LLC, Palo Alto, CA (US)

(72) Inventor: Jianshu CHEN, Woodinville, WA (US)

(73) Assignee: TENCENT AMERICA LLC, Palo Alto, CA (US)

(21) Appl. No.: 18/077,723

(22) Filed: Dec. 8, 2022

(51) Int. Cl. G06N 3/04

(52) U.S. Cl. CPC G06N 3/04; G06K 9/6259

(57) ABSTRACT

A method including receiving input comprising natural language texts; pre-training a First-Order Logic Network (FOLNet) neural network model on unlabeled texts included in the natural language texts, the FOLNet neural network model comprising of a plurality of layers; processing the input through the plurality of layers of the FOLNet neural network model; encoding a logical inductive bias using the FOLNet neural network model; outputting one or more tensors based on the logical inductive bias; and predicting an outcome using the one or more tensors.

### TECHNICAL FIELD

The present disclosure provides a method for language representation learning using logical inductive bias. Logic reasoning is known as a formal methodology to reach answers from given knowledge and facts.

### BACKGROUND

Pretrained transformer models have achieved great success in solving natural language tasks, which learn strong language representations from large-scale unlabeled texts. The learned representations can be easily transferred to different downstream tasks by tuning over limited amount of labeled data. The learned representations even exhibit strong zero-shot or few-shot generalization capability without fine-tuning when further scaling up the model size. Besides large-scale models and training data, one important reason for the success is the strong relational inductive bias encoded in the transformer architecture; it effectively models the pairwise relations between tokens and use it to compute the language representations.

There have been a long line of research on neural language models. Recently, there has been great success by exploring different variants of pretrained transformer models for solving downstream language tasks, such as with fine-tuning or with zero/few-shot learning using large language models. Another line of active research focuses on developing more effective pretraining losses beyond the widely used autoregressive or masked language modeling objectives. There have been limited works on developing new neural architectures for learning better language representations. The present disclosure seeks to move in this direction and develop a new neural architecture based on logical inductive bias.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

This disclosure provides a method for language representation learning using logical inductive bias.

According to some embodiments, there is provided a method performed by at least one processor. The method includes receiving input comprising natural language texts. The method further includes pre-training a First-Order Logic Network (FOLNet) neural network model on unlabeled texts included in the natural language texts. The FOLNet neural network model comprising of a plurality of layers. The method further includes processing the input through the plurality of layers of the FOLNet neural network model. The method further includes encoding a logical inductive bias using the FOLNet neural network model. The method further includes outputting one or more tensors based on the logical inductive bias. The method further includes predicting an outcome using the one or more tensors.

According to some embodiments, an apparatus includes at least one memory configured to store program code and at least one processor configured to read the program code and operate as instructed by the program code. The program code includes receiving code configured to cause the at least one processor to receive input comprising natural language texts. The program code further pre-training code configured to cause the at least one processor to pre-train a First-Order Logic Network (FOLNet) neural network model on unlabeled texts included in the natural language texts. The FOLNet neural network model comprising of a plurality of layers. The program code further includes processing code configured to cause the at least one processor to process the input through the plurality of layers of the FOLNet neural network model. The program code further includes encoding code configured to cause the at least one processor to encode a logical inductive bias using the FOLNet neural network model. The program code further includes outputting code configured to cause the at least one processor to output one or more tensors based on the logical inductive bias. The program code further includes predicting code configured to cause the at least one processor to predict an outcome using the one or more tensors

According to some embodiments, a non-transitory computer-readable storage medium, stores instructions that, when executed by at least one processor, cause the at least one processor to receive input comprising natural language texts. The instructions further cause the at least one processor to pre-train a First-Order Logic Network (FOLNet) neural network model on unlabeled texts included in the natural language texts. The FOLNet neural network model comprising of a plurality of layers. The instructions further cause the at least one processor to process the input through the plurality of layers of the FOLNet neural network model. The instructions further cause the at least one processor to encode a logical inductive bias using the FOLNet neural network model. The instructions further cause the at least one processor to output one or more tensors based on the logical inductive bias. The instructions further cause the at least one processor to predict an outcome using the one or more tensors.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other features and aspects of embodiments of the disclosure will be apparent from the following description taken in conjunction with the accompanying drawings, in which:

FIG. 1 is a diagram of an environment in which methods, apparatuses and systems described herein may be implemented, according to some embodiments.

FIG. 2 is a block diagram of example components of one or more devices of FIG. 1.

FIG. 3 is an overview of a transformer architecture, according to some embodiments.

FIG. 4 is an overview of a FOLNet architecture, according to some embodiments.

FIG. 5 is a flow chart of an example process for language representation learning using logical inductive bias, according to some embodiments.

### DETAILED DESCRIPTION

The following detailed description of example embodiments refers to the accompanying drawings. The same reference numbers in different drawings may identify the same or similar elements.

The following disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Transformer architectures have achieved great success in solving natural language tasks, which learn strong language representations from large-scale unlabeled texts. Embodiments may go further beyond and explore a new logical inductive bias for better language representation learning. Logic reasoning may be referred to as a formal methodology to reach answers from given knowledge and facts. Inspired by such a view, embodiments may relate to a novel neural architecture named FOLNet (First-Order Logic Network), to encode this new inductive bias.

Logical inductive bias may be used to view the computation of language representations as a logic reasoning process; that is, the language representations may be deduced via logic reasoning step-by-step from the original discrete token sequences. The tokens may be treated in the input sequence as the terms in logic programming, and their properties and relations may be treated as the predicates of different arities. Then, the final language representations may be derived as the advanced properties and relations from the basic input properties and relations (e.g., token ids and relative distances). The construction of such deduction process may follow the principles of first-order logic, in order to encode such logical inductive bias.

Natural language text can be viewed as a sequence of discrete symbols, and language representations learning considers the problem of mapping the discrete symbols into certain more computable forms. One approach may be distributed representation, which maps the discrete token ids into dense vectors. Many different functional forms, such as LSTM, and more recently, transformer models, have been used to implement such mappings. They generally encode different kinds of inductive bias for modeling natural languages. For example, RNNs use the same set of model parameters to update the hidden states over time, which encodes translation-invariance over time.

Embodiments may relate to a new form of inductive bias, named logical inductive bias, which will work together with distributed representations to design more effective representation mappings. Embodiments may be used to view the language representation mapping as a logic reasoning process; that is, the language representations are deduced step-by-step from the original discrete token sequences. The tokens in the input sequence are treated as terms (or objects) in logic programming, and their properties and relations are treated as predicates of different arities. In light of logical inductive bias, the language representations that are computed are the (advanced) properties and relations that can be deduced from these input (basic) properties and relations. The construction of such deduction process may follow the principles of first-order logic, in order to encode the logical inductive bias into the representation learning process. The language representation learning is formulated as a logic programming problem by adopting similar (logic programming) notations used presently.

Terms: Consider a first-order logic system without function symbols, so that terms can only be variables or constant. They are used to represent general objects or a particular object of interest, respectively. In the context of language representation learning, each instance of text sequence x (of length T) may be modeled as a collection of constants x={x₁, . . . , x_{T}}, where each token xt is a constant (t=1, . . . , T). In embodiments, lower-case letters may be used to denote constants and upper case for variables as in logic programming. For example, X is a variable to represent a general object (e.g., token).

Atoms: For each term, its properties and relations may be represented as an r-ary predicate p(X₁, . . . , Xᵣ), which takes the value of T (True) or F (False) depending on whether a certain property/relation regarding (X₁, . . . , Xᵣ) holds or not. For example, whether the a token a takes the v-th id in the vocabulary is a unary predicate TokenID, (a) for v=1, . . . , V, where V is the vocabulary size, and whether the distance between two tokens a and b is equal to d is a binary predicate Dist_{d}(a, b), for |d|<T. An atom is ground if it has no variables, e.g., the above TokenID, (a) and Dist_{d}(a, b) are all ground atoms.

Clauses: The reasoning process may be constructed by a set of “if-then” clauses in the form of Equation 1 below:

q←p₁∧ . . . ∧pₘ, (1)

where p₁, . . . , pₘ and q are the body atoms and head atoms, respectively, and A denotes conjunction (i.e., logical AND). These atoms play the roles of premises and conclusions: if p₁, . . . , pₘ are true, then q is also true. Clauses of the above form may be referred to as definite Horn clauses. A clause may be referred to as a ground rule if all its variables are substituted by constants. For example, when applying a substitution θ={a/X, b/Y} to a clause q(X, Y)←p(X, Y), we get a ground rule: q(a, b)←p(a, b). It can be viewed as applying a general clause to a particular instantiation.

In embodiments, a collection of clauses may be learned and composed into a mapping from input predicates (e.g., TokenIDᵥ(xt) and RelDist_{d}(xₜ, xₜ)) to language representations. For example, let R be a set of clauses and ground(R) be the corresponding set of ground rules. The immediate consequences of applying the ground rules in ground(R) to a set of ground atoms X may be represented as shown in Equation 2 below:

$${con}_{ℛ} ( 𝒳 ) = 𝒳 ⋃ \{ q \vert q ← {p}_{1} ∧ … ∧ {p}_{m} ∈ ground ( ℛ ) , {⋀}_{i = 1}^{m} {p}_{i} ∈ 𝒳 \} . \qquad ( 2 )$$

It can be understood as a set of ground atoms that can be deduced from X together with X itself. Given a set of input ground atoms B, embodiments may repeatedly apply the ground rules in R for L steps, as shown in Equation 3 below:

$${𝒞}_{l} = {con}_{ℛ} ( {𝒞}_{l - 1} ) , {C}_{0} = ℬ and l = 1 , … , L . \qquad ( 3 )$$

Then, C_{L} is all the possible ground atoms (predicates) that may be deduced from B (including B itself) in L steps. The above procedure may be referred to as forward-chaining: it deduces all the possible conclusions from the input premises (i.e., B) by repeatedly applying (i.e., chaining) clauses. To verify whether a predicate q′ holds (i.e., may be entailed), check if q′ is in CL. In language representation learning, start, for example, from the following input (basic) atoms as shown below in Equation 4:

$$ℬ = \{ {TokenID}_{v} ( {x}_{t} ) , {RelDist}_{d} ( {x}_{t} , {x}_{r} ) , … \vert t , τ = 1 , … , T \} , \qquad ( 4 )$$

and deduce C_{L} as the final representations by forward-chaining the (learned) clauses. For example, in solving an (extractive) question answering problem, whether a certain token is the beginning (or end) of the answer span is modeled as an advanced deduced property of this token, for example as shown below in Equation 5:

$${𝒞}_{L} = \{ AnswerStartsAt ( {x}_{i} ) , AnswerEndsAt ( {x}_{i} ) \vert t = 1 , … , T \} . \qquad ( 5 )$$

Table 1 summarizes examples of the above identifications between language representations and logic programming. Table 1 shows the identification of language representation learning as a logic programming problem.

TABLE 1

| Language representations | Logic programming | FOLNet |
|---|---|---|
| Tokens x [symbol] in the text sequence | Constant: x [symbol] | The argument: x [symbol] in tensor u [symbol] (x [symbol] ) |
| Token ids, relative distances, etc | Input (basic) atoms: C [symbol] = B | Input tensors: {u [symbol] (x), u [symbol] (x, y)} |
| Final langauge representation | Deduced (advanced) atoms: C_{L} | Output tensors: {u_{L}(x), u_{L}(w, y)} |
| Representation mapping (partial) | [symbol] -clause deduction: Modus Ponens (6) | Neural logic operator: see Table 2 |
| Representation mapping (partial) | [symbol] -step deduction; C [symbol] = con [symbol] (C [symbol] ₋₁) | Forward pass: [symbol] -layer |
| Representation mapping (full) | L-step deduction: forward-chaining (3) | Forward pass: L-layer |

[symbol]

indicates data missing or illegible when filed

An r-ary ground atom p_{d}(x₁, . . . , xᵣ) is used to characterize whether the d-th property/relation holds for a tuple of tokens (x₁, . . . , xᵣ), where d=1, . . . , Dᵣ. To overcome the difficulty of learning these discrete-valued atoms, which takes values in {T,F}, embodiments may use u_{d}(x₁, . . . , xᵣ)∈R as its continuous representation and characterizes the extent to which the atom pd is true. For example, in ProbLog u_{d}(⋅) gives the probability of the atom pd being true. Let u(x₁, . . . , xᵣ)∈U⊂R^{Dr} be a Dr-dimensional vector that collects u_{d}(x₁, . . . , xᵣ) as its r-th element. Then, u(x₁, . . . , xᵣ) will be a continuous vector representation for Dᵣ atoms with arity r. For example, for an input text sequence x=(x₁, . . . , x_{T}), embodiments may use u(xₜ) to represent D₁ (unary) properties for each token xₜ, and use u(xₜ, x₁) to characterize D₂ (binary) relations between any pair of tokens. Both the input (basic) properties/relations and the deduced (advanced) ones will be represented in the same continuous vector space, where the deduction process will be carried out. For convenience, a set of atoms may be represented by their vector representation u(⋅).

In embodiments, a set of neural operators may be used for implementing the deduction step characterized in Equation (2). To begin with, embodiments may use the Modus Ponens (MP) rule from first-order logic, which states that if clause B←A and statement A hold, then B is true, for example as shown below in Equation 6:

B⇐={B←A and A}. (6)

In the context of Equation (2), when choosing A=p1∧ . . . ∧pm and B=q, the deduction in Equation (2) may be viewed as an application of the MP inference using all the ground clauses in ground(R). Embodiments may restrict the focus to the setting where all the atoms have arity of either one or two. That is, embodiments may only consider all the atoms of the form u(xₜ) and u(xₜ, xₜ) (represented in their vector forms), respectively. Then, the MP inference may be developed from a set of atoms {v(a), v(a, b)} to another set of atoms {u(x), u(x, y)}, which can be categorized into the following four groups:

u(x)⇐R_{UU},v(a); u(x)⇐R_{UB},v(a,b); u(x,y)⇐R_{BU},v(a); u(x,y)⇐R_{BB},v(a,b);

where R_{UU}, R_{UB}, R_{BU} and R_{BB} denote the sets of rules that deduce atoms of a certain arity from another arity. For example, R_{BU} defines a collection of clauses that derives binary (B) atoms from unary (U) atoms. Embodiments may approximate the above MP inferences using the following Equations 7-10:

$$u ( x ) = {\sum }_{a} {K}_{UU} ( x , a ) v ( a ) \qquad ( 7 )$$

$$u ( x ) = {\sum }_{a , b} {K}_{UB} ( x , a , b ) v ( a , b ) \qquad ( 8 )$$

$$u ( x , y ) = {\sum }_{a} {K}_{BU} ( x , y , a ) v ( a ) \qquad ( 9 )$$

$$u ( x , y ) = {\sum }_{a , b} {K}_{BB} ( x , y , a , b ) v ( a , b ) \qquad ( 10 )$$

where K_{UU}(x, a), K_{UB}(x, a, b), K_{BU}(x, y, a) and K_{BB}(x, y, a, b) are D₁×D₁, D₁×D₂, D₂×D₁ and D₂×D₂ matrices that correspond to R_{UU}, R_{UB}, R_{BU} and R_{BB}, respectively. In embodiments, these matrices may correspond to the matrix representations of their corresponding set of clauses, similar to the vector representations for atoms as described above. Therefore, K_{UU}(x, a), K_{UB}(x, a, b), K_{BU}(x, y, a) and K_{BB}(x, y, a, b) can be interpreted as the kernels that implement the clauses in R_{UU}, R_{UB}, R_{BU} and R_{BB}, respectively. These may be referred to as the kernel-of-clauses (or kernels for short).

In embodiments, directly implementing the above MP inference Equations (7)-(10) may result in the high computation and memory costs. For example, the kernel K_{BB}(x, y, a, b) needs O(D₂²T⁴) to store its value. When properly reshaping K and v on the right-hand-side of Equations (7)-(10) and jointly considering the summation and matrix multiplication, each expression in Equations (7)-(10) can be equivalent to one huge matrix-vector multiplication. For example, Equation (10) is equivalent to multiplying a T²D₂×T²D₂ matrix with a T²D₂ vector, which has a computation complexity of O(D₂T⁴). Therefore, embodiments may restrict the size of the kernel and reduce the overall complexity by using different methods, such as sharing the values of K_{BB}(x, y, a, b) across different dimensions. Embodiments may provide a systematic approach which may be based on the following principles:

Restrict all the kernels to be in the form of {K(ω), K(ω, v)}, i.e., the arity r=1, 2.

Pick one dimension for reduction and another for broadcasting in the matrix multiplication.

With the above assumption, factor the predicate dimension of the unary kernel and the unary atom so that K_{d}(ω)=Kₕₛ(ω) and u_{d}(x)=uₕₛ(x), where d=(h−1)S+s with h=1, . . . , H and s=1, . . . , S. This is inspired by the multi-head attention mechanism, where h is akin to the head index, H is the number of heads and S is the size of the head. Then, enumerate all possible neural logic operators that can compatibly multiply a kernel from {K(ω),K(ω,v)} with a premise from {v(a), v(a, b)} by properly choosing different reduction and the broadcasting dimensions. With this, list the resulting neural logic operators for each typing in Table 2.

In embodiments, the j-operator and the a-operator may share similar forms as the self-attention mechanism in transformers, where the a-operator computes the self-attention scores and the j-operator performs the self-attention operation. Furthermore, the m-operator and the p-operator may generalize the existing relative positional encodings developed in, which are widely used in different transformer variants, such as in T5 models. Specifically, with some simple derivation, by making v_{w}(x, y) instance-independent (i.e., does not have the batch-dimension), the p-operator K computes the second term in equation (5) of Shaw et al. (2018), where v_{w} (x, y) play the role of aᵢⱼ. And by setting vₛ(x, a) instance-independent, the m-operator computes the second term in equation (3), where vₛ(x,a) plays the role of aᵢⱼ. That is, under such degenerated settings, these two operators will compose the relative positional encoding developed therein. The aᵢⱼ^{K} and aᵢⱼ^{V} are static learnable embeddings while the v_{w}(x, y) and vₛ(x, a) can indeed be dynamic and instance-dependent. The embeddings are dynamically computed for each instance in FOLNet. Therefore, the m-op and p-op may be viewed as a more adaptive relative positional encoding, which is also layer-adaptive in the network.

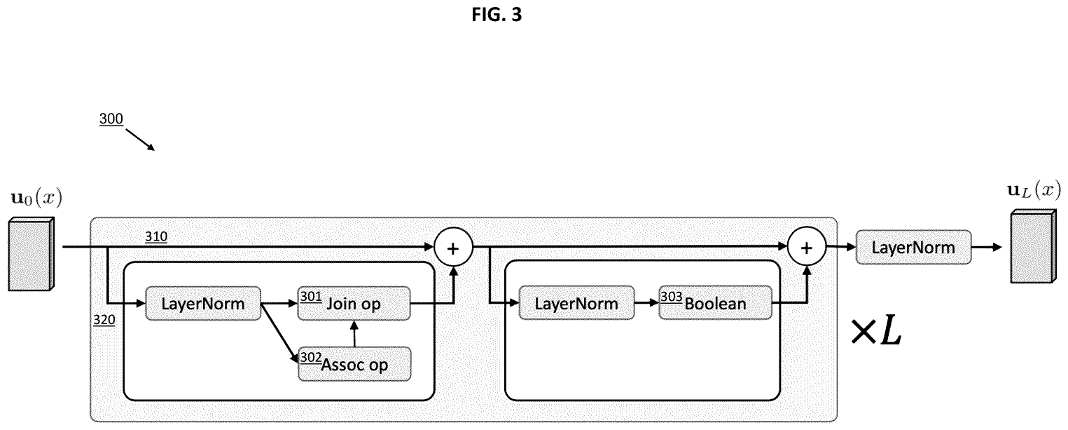

In general, a logic operator takes a kernel K and a premise v to computes a conclusion u (Table 2). Specifically, the logic operator “neutralizes” the logic deduction in Equation (2) for a particular typing (e.g., U←B×U). Applying all the neural logic operators amounts to have a full execution of Equation (2), which is one recursion step in Equation (3) that maps a set of {uₗ₋₁(x), uₗ₋₁(x, y)} into {uₗ(x), uₗ(x, y)}. Therefore, embodiments may naturally forward-chain L stages of them together to create a fully-differentiable architecture that models the reasoning chain in Equation (3). FIG. 3 depicts such forward-chaining process and also how it encodes the logical inductive bias. One remaining problem is how to obtain the kernels K(⋅) and the premises v(⋅) from our FOLNet architecture in FIG. 3. Embodiments may apply two linear projections (one for the premise and one for the kernel) to the previous layer's output {uₗ(x), uₗ(x, y)}. For the kernel, embodiments may further apply an activation function after the linear projection to compute the kernel (see Table 2 for the list of kernel activation functions for each operator). In other words, embodiments may parameterize the kernels K(⋅) and the premises v(⋅) by (the intermediate deduction results of) FOLNet itself. This is based on the observation that clauses are themselves predicates since A←B is defined as A∨¬B (Andrews, 2013), where ∨ and ¬ denote disjunction (logical OR) and negation, respectively.

FIG. 3 illustrates an example the input and the output of FOLNet, according to embodiments. At the input, some embodiments encode the discrete token ids for a token xₜ into vectors of the form u₀(xₜ) by standard embedding lookup. Likewise, some embodiments also convert the (discrete) relative distance between two tokens xₜ and xₜ into a vector of the form u₀(xₜ, x_{τ}). The {u₀(xₜ), u₀(xₜ, x_{τ})}_{t,τ} may be used as vector representations of the base atoms B and fed into the FOLNet model. After L layers (i.e., L steps of deduction), the output {u_{L}(xₜ), u_{L}(xₜ, x_{τ})}_{t,τ} becomes the vector representations of C_{L} in Equation (3), which is used as the final language representations. Therefore, the FOLNet model has the same input-output interface as other transformer models and can be used in a plug-and-play manner for solving downstream tasks. Because of this, the model may also be pretrained over large-scale texts using the same losses (e.g., MLM, NSP, SOP, etc) as the other models.

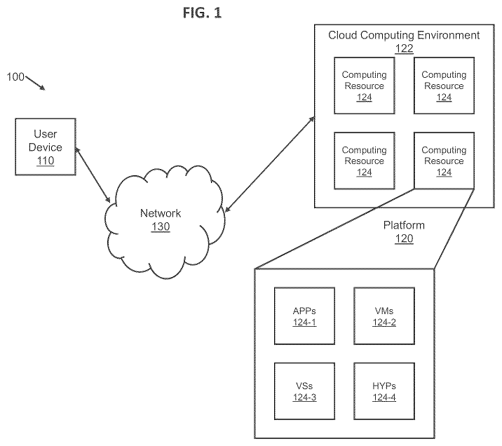

FIG. 1 is a diagram of an environment 100 in which methods, apparatuses and systems described herein may be implemented, according to embodiments.

As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g., the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g., a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program, and may support a single process. In some implementations, the virtual machine 124-2 may execute on behalf of a user (e.g., the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g., “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 may include one or more wired and/or wireless networks. For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

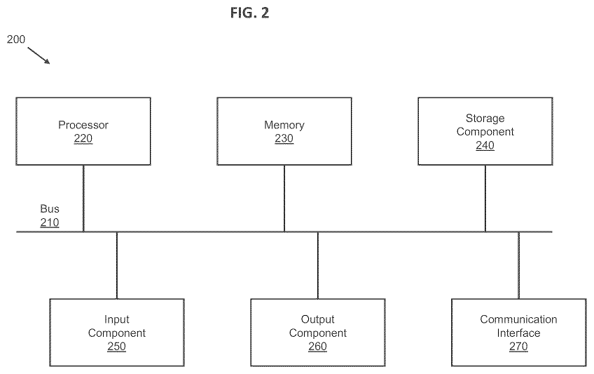

FIG. 2 is a block diagram of example components of one or more devices of FIG. 1.

A device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g., a touch screen display, a keyboard, a keypad, a mouse, a button, a switch, and/or a microphone). Additionally, or alternatively, the input component 250 may include a sensor for sensing information (e.g., a global positioning system (GPS) component, an accelerometer, a gyroscope, and/or an actuator). The output component 260 includes a component that provides output information from the device 200 (e.g., a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

FIG. 3 is an overview of a transformer architecture 300 according to some embodiments. The architecture 300 is a single-branch version of the FOLNet architecture with only join-operator and assoc-operator. As seen in FIG. 3 the FOLNet architecture includes a set of neural logic operators 303 as learnable Horn clauses (i.e., the MixerOps and Boolean), which are further forward-chained into a fully differentiable neural architecture. As seen in FIG. 3 the FOLNet architecture consists of two interacting branches, the upper branch 310 and the lower branch 320 responsible for unary and binary relational reasoning, respectively. Interestingly, the self-attention mechanism may be constructed by two developed neural logic operators, and the entire transformer architecture may be understood as a single-branch version of FOLNet. This newly discovered connection might partially explain the surprisingly strong reasoning performance of the transformer architecture.

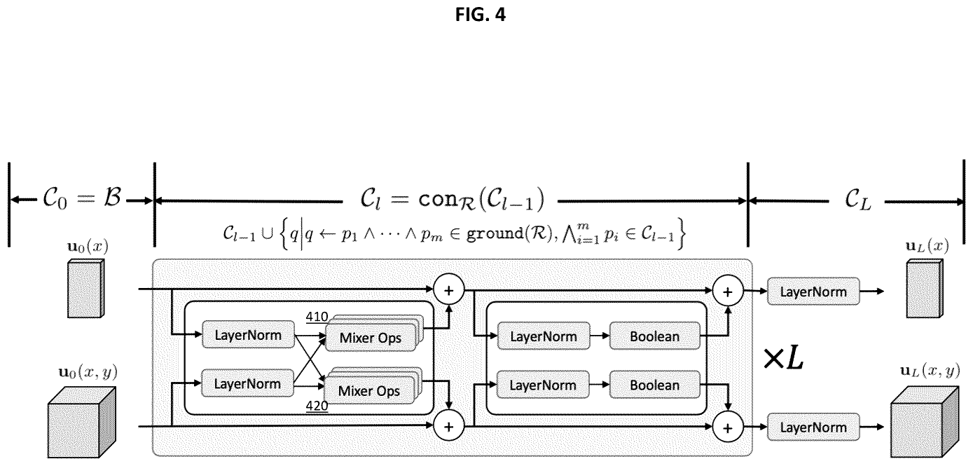

FIG. 4 is an overview of a FOLNet architecture 400 according to some embodiments. The overview shows how the FOLNet architecture 400 encodes the logical inductive bias. The neural logic operators model the clauses, which are forward-chained into a differentiable model. The Mixer Ops 410 and 420 refer to the operators c, j, m, and t that reduce over the object dimension. The operators are defined in further detail in Table 2.

Table 2 lists all of the neural logic operators with restricted kernels. “B-dim.” stands for the broadcast dimension and “R-dim.” means the reduction dimension. Each operator will have a unique broadcast dimension and a unique reduction dimension. The typing of the operator defines type of the input kernel and atoms along with the output atoms. For example, U←B×U means the arities of the kernel, the input atom, and the output atom are 2, 1 and 1, respectively. Table 2 also lists the activation functions that are used to compute the corresponding kernels, where the normalization dimension of Softmax is listed in its subscript.

TABLE 2

| Sym. | Ops. | Typing | B-dim. | R-dim. | Definition of the operator | Kernel act. | Remarks |
|---|---|---|---|---|---|---|---|
| b | bool | U ← U × U | x | w | u [symbol] (x) = Σ_{w} K [symbol] (x)v [symbol] (x) | GeLU/Identity | |
| c | cjoin | U ← U × B | [symbol] | a | u [symbol] (x) = Σ [symbol] K [symbol] (a)v [symbol] (x, a) | Softmax [symbol] | |
| j | join | U ← B × U | [symbol] | a | u [symbol] (x) = Σ [symbol] K [symbol] (x, a)v [symbol] (a) | Softmax [symbol] | Self-attention |
| m | mu | U ← B × B | x | a | u [symbol] (x) = Σ [symbol] K [symbol] (x, a) v [symbol] (x, a) | Softmax [symbol] | General RPE |
| a | assoc | B ← U × U | [symbol] | w | u [symbol] (x, y) = Σ_{w} K [symbol] (x)v [symbol] (y) | GelU/Identity | Self-attention |
| p | prod | B ← U × B | x | w | u [symbol] (x, y) = Σ_{w} K [symbol] (x)v [symbol] (x, y) | GeLU/Identity | General RPE |
| t | trans | B ← B × B | [symbol] | a | u [symbol] (x, y) = Σ [symbol] K [symbol] (x, a)v [symbol] (a, y) | Softmax [symbol] | |

[symbol]

indicates data missing or illegible when filed

The dual-branch architecture used in some embodiments has several significant advantages that are essential for learning better language representations. A new unified understanding of different positional encoding strategies with the logical inductive bias is established. The existing popular relative positional encoding may be constructed by the degenerated version of the two neural logic operators and allows for the development of a new principled relative positional encoding that is simple yet quite effective in practice. The disclosed FOLNet architecture has the same input and output interfaces as other pretrained transformer models (e.g., BERT) and thus could be trained by using similar losses. The architecture also allows FOLNet to be used in a plug-and-play manner when replacing other pretrained models in solving downstream natural language understanding tasks. The logical inductive bias assumes that the “logic deduction skills” are shared across all natural language tasks; that is, these skills learned during pretraining should be equally applicable to solving diverse downstream tasks. For this reason, FOLNet learns language representations that have much stronger transfer generalization capabilities. Experimental results on several language understanding tasks (GLUE, SQuAD 2.0 and FOLIO) show that the FOLNet model outperforms the transformer architecture by a large-margin when they are pretrained using similar losses. The results clearly show that advantage of using the logical inductive bias for learning language representations.

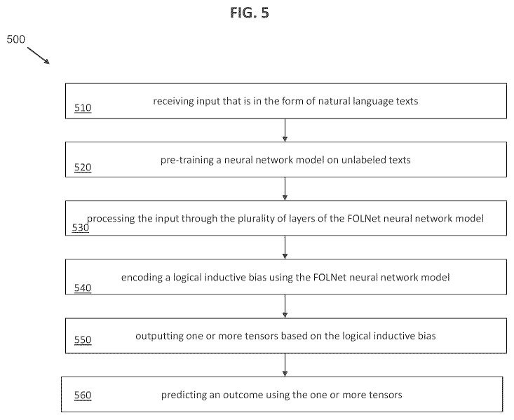

FIG. 5 is a flowchart of example process 500 for language representation learning using logical inductive bias. In some implementations, one or more process blocks of FIG. 5 may be performed by any of the elements discussed above.

As shown in FIG. 5, process 500 include receiving input that is in the form of natural language texts (block 510).

As further shown in FIG. 5, the process 500 may include pre-training a neural network model on unlabeled texts. The neural network model being a First-Order Logic Network (FOLNet) model comprising of a plurality of layers (block 520).

As further shown in FIG. 5, the process 500 may include processing the input through the plurality of layers of the FOLNet neural network model (block 530).

As further shown in FIG. 5, the process 500 may include encoding a logical inductive bias using the FOLNet neural network model (block 540).

As further shown in FIG. 5, the process 500 may include outputting one or more tensors based on the logical inductive bias (block 550).

As further shown in FIG. 5, the process 500 may include predicting an outcome using the one or more tensors (block 560).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local region network, a wide region network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local region network (LAN) or a wide region network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, implement the operations specified in the flowchart and/or block diagram block or blocks. These computer readable program instructions may also be stored in a computer readable storage medium that may direct a computer, a programmable data processing apparatus, and/or other devices to operate in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the operations specified in the flowchart and/or block diagram block or blocks.

The flowchart and block diagrams in the figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical operation(s). The method, computer system, and computer readable medium may include additional blocks, fewer blocks, different blocks, or differently arranged blocks than those depicted in the Figures. In some alternative implementations, the operations noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified operations or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method executed by at least one processor, the method comprising:
receiving input comprising natural language texts;
pre-training a First-Order Logic Network (FOLNet) neural network model on unlabeled texts included in the natural language texts, the FOLNet neural network model comprising of a plurality of layers;
processing the input through the plurality of layers of the FOLNet neural network model;
encoding a logical inductive bias using the FOLNet neural network model;
outputting one or more tensors based on the logical inductive bias; and
predicting an outcome using the one or more tensors.

2. The method according to claim 1, wherein outputting the one or more tensors comprises preprocessing the input into one or more tokens to be converted into the one or more tensors.

3. The method according to claim 1, wherein the FOLNet neural network model further comprises a first interacting branch for unary relational reasoning and a second interacting branch for binary relational reasoning.

4. The method according to claim 1, further comprising constructing a set of neural logic operators as learnable Horn clauses.

5. The method according to claim 4, wherein the set of neural logic operators are forward-chained into the FOLNet neural network model.

6. The method according to claim 5, wherein the FOLNet neural network model is a fully differentiable neural architecture.

7. The method according to claim 1, wherein the pre-training the neural network model on unlabeled texts comprises training the neural network model to solve one or more downstream tasks.

8. An apparatus comprising:
at least one memory configured to store program code; and
at least one processor configured to read the program code and operate as instructed by the program code, the program code comprising:
receiving code configured to cause the at least one processor to receive input comprising natural language texts;
pre-training code configured to cause the at least one processor to pre-train a First-Order Logic Network (FOLNet) neural network model on unlabeled texts included in the natural language texts, the FOLNet neural network model comprising of a plurality of layers;
processing code configured to cause the at least one processor to process the input through the plurality of layers of the FOLNet neural network model;
encoding code configured to cause the at least one processor to encode a logical inductive bias using the FOLNet neural network model;
outputting code configured to cause the at least one processor to output one or more tensors based on the logical inductive bias; and
predicting code configured to cause the at least one processor to predict an outcome using the one or more tensors.

9. The apparatus according to claim 8, wherein the outputting code is further configured to cause the at least one processor to preprocess the input into one or more tokens to be converted into the one or more tensors.

10. The apparatus according to claim 8, wherein the FOLNet neural network model further comprises a first interacting branch for unary relational reasoning and a second interacting branch for binary relational reasoning.

11. The apparatus according to claim 8, wherein the program code further comprises constructing code configured to cause the at least one processor to construct a set of neural logic operators as learnable Horn clauses.

12. The apparatus according to claim 11, wherein the set of neural logic operators are forward-chained into the FOLNet neural network model.

13. The apparatus according to claim 12, wherein the FOLNet neural network model is a fully differentiable neural architecture.

14. The apparatus according to claim 8, wherein the pre-training code is further configured to cause the at least one processor to train the neural network model to solve one or more downstream tasks.

15. A non-transitory computer-readable storage medium, storing instructions, which, when executed by at least one processor, cause the at least one processor to:
receive input comprising natural language texts;
pre-train a First-Order Logic Network (FOLNet) neural network model on unlabeled texts included in the natural language texts, the FOLNet neural network model comprising of a plurality of layers;
process the input through the plurality of layers of the FOLNet neural network model;
encode a logical inductive bias using the FOLNet neural network model;
output one or more tensors based on the logical inductive bias; and
predict an outcome using the one or more tensors.

16. The non-transitory computer-readable storage medium according to claim 15, wherein the instructions further cause the at least one processor to preprocess the input into one or more tokens to be converted into the one or more tensors.

17. The non-transitory computer-readable storage medium according to claim 15, wherein the FOLNet neural network model further comprises a first interacting branch for unary relational reasoning and a second interacting branch for binary relational reasoning.

18. The non-transitory computer-readable storage medium according to claim 15, wherein the instructions further cause the at least one processor to construct a set of neural logic operators as learnable Horn clauses.

19. The non-transitory computer-readable storage medium according to claim 18, wherein the set of neural logic operators are forward-chained into the FOLNet neural network model.

20. The non-transitory computer-readable storage medium according to claim 19, wherein the FOLNet neural network model is a fully differentiable neural architecture.
